(19) United States
(12) Patent Application Publication
(10) Pub. No.: US 2026/0060236 A1
(43) Pub. Date: Mar. 5, 2026

(54) RODENT-BLOCKING VENT CAP

(71) Applicant: David Schuelke, Park City, UT (US)

(72) Inventor: David Schuelke, Park City, UT (US)

(21) Appl. No.: 18/818,484

(22) Filed: Aug. 28, 2024

(51) Int. Cl. A01M 29/30; E03B 7/07

(52) U.S. Cl. CPC A01M 29/30; E03B 7/07

(57) ABSTRACT

A vent cap for a sewer exhaust pipe of a residential or commercial building, or for another type of exhaust pipe, the vent cap operable to prevent ingress of rodents into said pipe. The vent cap comprises a raised, vented structure having a plurality of apertures and a plurality of tiered, birthday-caked concentric interior flanges operable to form a friction fit with a plurality of standard-sized exhaust pipes.

### FIELD OF THE INVENTION

This invention relates to rodent abatement and more particularly relates to a vent cap operable to prevent entry of rodents into a pipe system such as a sewer line.

### BACKGROUND

### Description of the Related Art

Plumbing vent stacks are known in the art and protrude through a roof deck of a residence or commercial building and are necessary to vent and disperse sewer gases from sewer lines, including methane. These plumbing stacks can be weatherproofed with a cover fitted over the plumbing vent stack. Covers are generally designed for a single-diameter pipe/stack and must usually be manually hammered and forced over the distal end of the vent stack and down thereinto to effect a complete weatherproof and rodent-proof fit.

The vent cover can be chewed and even eaten away in parts by rodents when formed of light polymeric material, light metal alloys, or organic materials such as wood. Rodents are then able to gain access to toilets, sinks and drains within the home or commercial building.

A vent stack which overcomes these difficulties inherent in the art is therefore desirable.

### SUMMARY

From the foregoing discussion, it should be apparent that a need exists for a rodent-blocking vent cap. Accordingly, the present invention has been developed to provide a vent cap operable to prevent entry of a rodent into an exhaust pipe, the vent cap comprising: a cylindrical body having an open bottom end defining a hollow interior cavity; a dome-shaped, raised vented structure affixed to the cylindrical body, the dome-shaped raised vented structure defining a plurality of apertures; a tapered interior frustocone disposed within the hollow interior cavity, the tapered interior frustocone comprising a plurality of narrowing concentric flanges, each narrowing concentric flange smaller in diameter than a narrowing concentric flange immediately below; wherein each narrowing concentric flange is dimensioned to form a friction fit with a standard-sized pipe.

The dome-shaped, raised vented structure and cylindrical body may be formed as a single integrated piece. A collective surface area of the vents may exceed a surface area of the open bottom end in some embodiments. The vent cap may further comprise an annular flange affixed to the dome-shaped, raised vented surface around a center point of the dome-shaped raised vented surface. The tapered interior frustocone may consist of four concentric flanges.

The dome-shaped, raised vented structure may define a plurality of bores through which spikes may traverse to deter fowl from landing on the dome-shaped, raised vented structure.

The dome-shaped, raised vented structure and cylindrical body may detachably connect to one another using one of: a friction fit, a snap fit, and threading.

A second vent cap operable to prevent entry of a rodent into an exhaust pipe is provided, the vent cap comprising: a cylindrical body having an open bottom end defining a hollow interior cavity; a raised vented structure affixed to the cylindrical body, the raised vented structure defining a plurality of apertures; a tapered interior frustocone disposed within the hollow interior cavity, the tapered interior frustocone comprising a plurality of narrowing concentric flanges, each narrowing concentric flange smaller in diameter than a narrowing concentric flange immediately below; wherein each narrowing concentric flange is dimensioned to form a friction fit with a standard-sized pipe.

The raised vented structure and cylindrical body may be formed as a single integrated piece.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an isometric perspective view illustrating one embodiment of a rodent-blocking vent cap in accordance with the present invention;

FIG. 1B is an exploded isometric perspective view illustrating one embodiment of a rodent-blocking vent cap in accordance with the present invention;

FIG. 2 is a side perspective view illustrating one embodiment of a rodent-blocking vent cap in accordance with the present invention;

FIG. 3 is a sectioned, side perspective view illustrating one embodiment of a rodent-blocking vent cap in accordance with the present invention;

FIG. 4 is a sectioned, top perspective view illustrating one embodiment of a rodent-blocking vent cap in accordance with the present invention;

FIG. 5 is a sectioned, top perspective view illustrating one embodiment of a rodent-blocking vent cap in accordance with the present invention;

FIG. 6 is an exploded top perspective view illustrating one embodiment of a rodent-blocking vent cap in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide a rodent-blocking vent cap 100 which prevents entry of rodents in sewer vent pipes atop roofs.

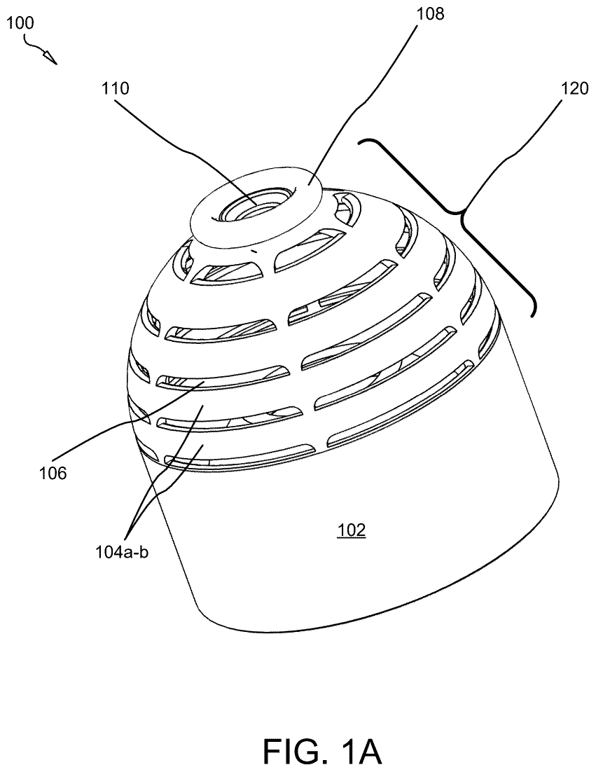

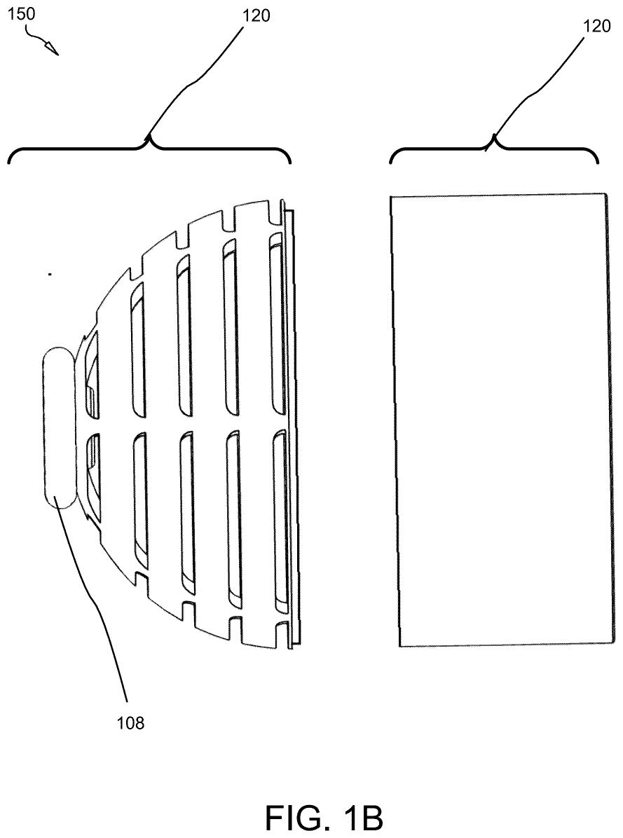

FIG. 1A is an isometric perspective view illustrating one embodiment of a rodent-blocking vent cap 100 in accordance with the present invention.

The cap 100 may comprise a raised vented structure 120. The top surface of the raised vented structure 120 may be convex or domed. In some embodiments, the top surface and raised vented structure 120 is tapered and/or frustoconical. A plurality of arcuate vents 104 may position centrically around a center point 110 of the cap 100. The vents 104 may be arcuate, rectangular, or regularly-or irregularly-shaped. The vents 104 may position at regular, repeating intervals or in irregular patterns.

An annular flange 108 positions around the center point 110 in some embodiments. In various embodiments, the annular flange 108 between 2 mm and 12 mm wide. The annular flange may be between 4 mm and 8 mm wide.

FIG. 1B is an exploded isometric perspective view illustrating one embodiment of a rodent-blocking vent cap 150 in accordance with the present invention.

In various embodiments, the raised vented structure 120 detaches from the cylindrical body 102. The raised vented structure 120 may interconnect with the cylindrical body 102 using a snap fit, friction fit, other means known to those of skill in the art. One of the cylindrical body 102 and raised vented structure 120 may be threaded. The raised vented structure 120 may mate with the cylindrical body 102 using a male-female coupling. In this manner, a user may access the bottom of the dome or raised vented structure 120 to insert bird stop spikes as further discussed below.

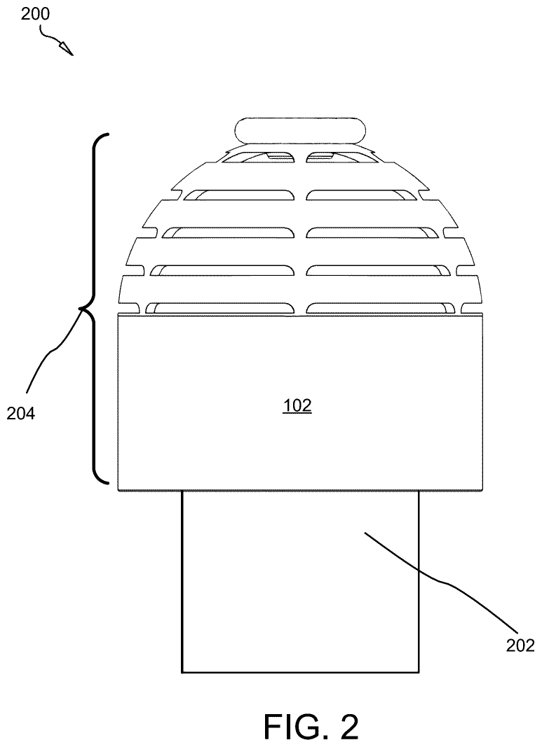

FIG. 2 is a side perspective view illustrating one embodiment of a rodent-blocking vent cap in accordance with the present invention.

The body 202 of the cap 200 is wider than the pipe 202 over which the cap 200 is positioned.

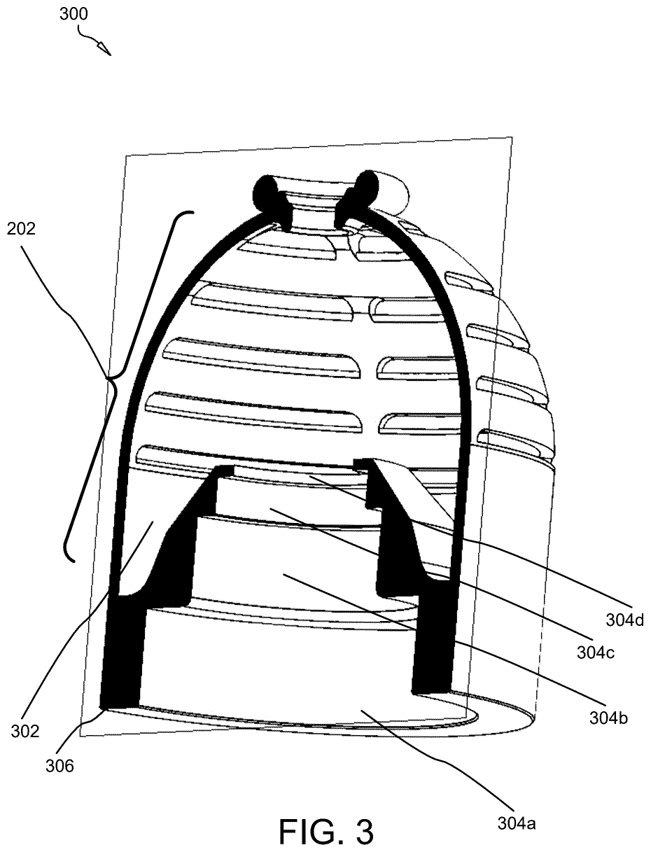

FIG. 3 is a sectioned, side perspective view illustrating one embodiment of a rodent-blocking vent cap 300 in accordance with the present invention.

As shown, the cap 300 comprises a hollow interior cavity 302 in which a tiered, birthday-caked structure 306 disposes which tapers superiorly as it rises. This tiered structure 306 comprises a plurality of concentric flanges 304a-d, each concentric flange 304 narrower in diameter than a concentric flange 304 beneath (if any). The diameter of each concentric flange 304 is dimensioned to form a friction fit with a pipe 202 of standard diameter.

The tiered, birthday-caked structure 306 may detachably insert into an open bottom end of the apparatus 300 and connect therewith using means known to those of skill in the art, such as adhesive, a friction fit, a snap fit and the like, including threading.

In this manner, the cap 300 is operable to be interchangeable/compatible with a plurality of standard-sized exhaust pipes 202. The inserted pipe 202 forms a friction fit with the cap 300 and a top surface of the pipe 202 rests on a lower surface of a narrower concentric flange above.

The vent cap is configured and operable to fit standard sized exhausts, including four inch, three inch, two inch and 1.5 inch ABS or PVC pipes.

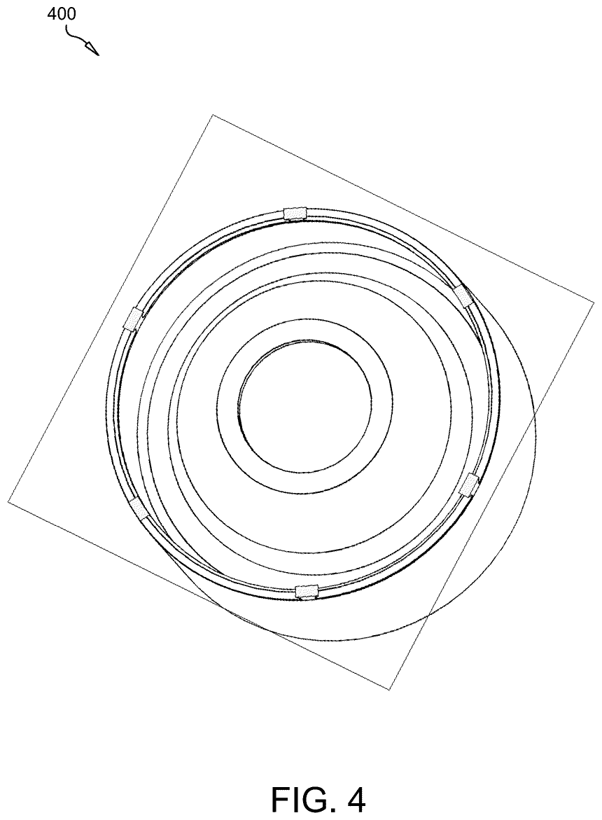

FIG. 4 is a sectioned, top perspective view illustrating one embodiment of a rodent-blocking vent cap 300 in accordance with the present invention.

As shown.

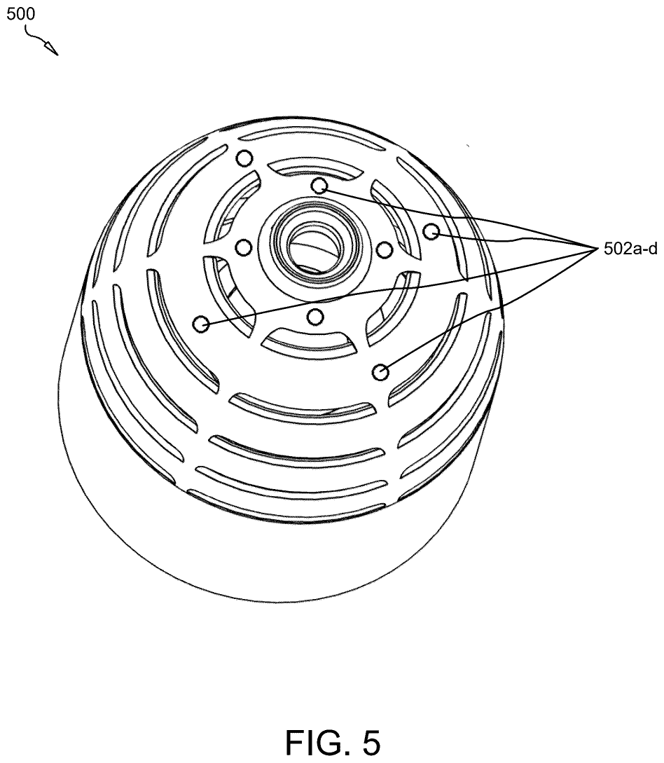

FIG. 5 is a sectioned, top perspective view illustrating one embodiment of a rodent-blocking vent cap 500 in accordance with the present invention.

In various embodiments, the raised, vented structure 120 defines a plurality of bores 502 (or apertures) operable to permit through traverse of spikes, screws, rods or nails. These spikes deter fowl from landing on the raised vented structure 120.

These spikes may be screwed through the bores 502 before the raised vented structure 120 is affixed to the cylindrical body 102. In various embodiments, the apparatus 500 defines four bores 502. In other embodiments, the structure 120 defines 1 -8 bores 502.

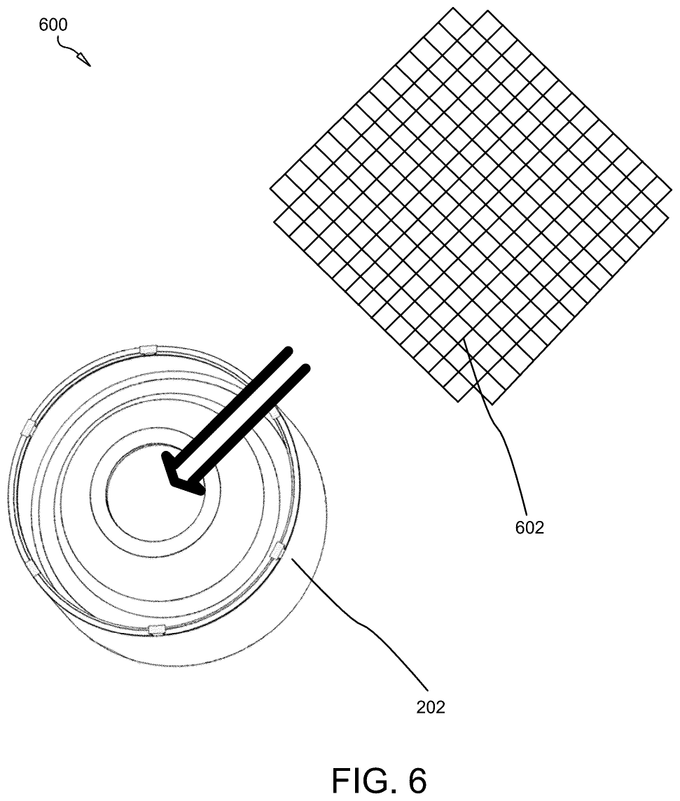

FIG. 6 is an exploded top perspective view illustrating one embodiment of a rodent-blocking vent cap 600 in accordance with the present invention.

In various embodiments, a screen 602, which may be in lattice form, positions over one of the raised vented structure 120 and the cylindrical body 202. The screen 602 may be formed from metallic, alloy or polymeric materials. In various embodiments, the screen 602 affixes to the cylindrical body using one of screws or snapping mechanisms. The screen 602 may insert between the cylindrical body 202 and the raised vented structure 120.

The present invention may be embodied in other specific forms without departing from its spirit or essential characteristics. The described embodiments are to be considered in all respects only as illustrative and not restrictive. The scope of the inventio is, therefore, indicated by the appended claims rather than by the foregoing description. All changes which come within the meaning and range of equivalency of the claims are to be embraced within their scope.

What is claimed is:

1. A vent cap operable to prevent entry of a rodent into an exhaust pipe, the vent cap comprising:
a cylindrical body having an open bottom end defining a hollow interior cavity;
a dome-shaped, raised vented structure affixed to the cylindrical body, the dome-shaped raised vented structure defining a plurality of apertures;
a tapered interior frustocone disposed within the hollow interior cavity, the tapered interior frustocone comprising a plurality of narrowing concentric flanges, each narrowing concentric flange smaller in diameter than a narrowing concentric flange immediately below;
wherein each narrowing concentric flange is dimensioned to form a friction fit with a standard-sized pipe.

2. The vent cap of claim 1, wherein the dome-shaped, raised vented structure and cylindrical body are formed as a single integrated piece.

3. The vent cap of claim 1, wherein a collective surface area of the vents exceeds a surface area of the open bottom end.

4. The vent cap of claim 1, further comprising an annular flange affixed to the dome-shaped, raised vented surface around a center point of the dome-shaped raised vented surface.

5. The vent cap of claim 1, wherein the tapered interior frustocone consists of four concentric flanges.

6. The vent cap of claim 1, wherein the dome-shaped, raised vented structure defines a plurality of bores through which spikes may traverse to deter fowl from landing on the dome-shaped, raised vented structure.

7. The vent cap of claim 1, wherein the dome-shaped, raised vented structure and cylindrical body detachably connect to one another using one of: a friction fit, a snap fit, and threading.

8. A vent cap operable to prevent entry of a rodent into an exhaust pipe, the vent cap comprising:
a cylindrical body having an open bottom end defining a hollow interior cavity;
a raised vented structure affixed to the cylindrical body, the raised vented structure defining a plurality of apertures;
a tapered interior frustocone disposed within the hollow interior cavity, the tapered interior frustocone comprising a plurality of narrowing concentric flanges, each narrowing concentric flange smaller in diameter than a narrowing concentric flange immediately below;
wherein each narrowing concentric flange is dimensioned to form a friction fit with a standard-sized pipe.

9. The vent cap of claim 1, wherein the raised vented structure and cylindrical body are formed as a single integrated piece.
